(19) United States
(12) Patent Application Publication
(10) Pub. No.: US 2011/0072112 A1
(43) Pub. Date: Mar. 24, 2011

(54) ELECTRIC VEHICLE DATA-APPLICATION CONNECTOR SYSTEM

(75) Inventor: David L. Kaplan, Seattle, WA (US)

(73) Assignee: David S. Kaplan, Seattle, WA (US)

(21) Appl. No.: 12/878,136

(22) Filed: Sep. 9, 2010

Related U.S. Application Data
(60) Provisional application No. 61/245,165, filed on Sep. 23, 2009.

(51) Int. Cl. G06F 15/16; G06F 9/44; G06F 9/455

(52) U.S. Cl. 709/218; 719/328; 718/1; 709/228

(57) ABSTRACT

EV-DACS renders more efficient the transfer of data between one or more programs of an application software system by one manufacturer with one or more electric vehicle assets by another manufacturer to efficiently facilitate monitoring or control for one or more purposes according to any standard. Further, such transfer and control is made entirely possible if the software and physical assets are otherwise incompatible.

### PRIORITY

The present application claims priority to provisional U.S. patent application entitled “Electric Vehicle Data-Application Connector System,” U.S. provisional No. 61/245,165, filed in the U.S. Patent and Trademark Office on Sep. 23, 2009.

### FIELD

The embodiments described herein are relevant to communications to and from plug-in electric vehicles (EVs), electric vehicle supply equipment (EVSE) and other systems with which these components interact.

### BACKGROUND

The emerging electric vehicle “ecosystem” includes several classes of components, which include “electric vehicles” (alternately referred herein as “EV”) and “electric vehicle supply equipment” (alternately referred herein as “EVSE”). The terms, as used within the present disclosure and claims, are to be understood in accordance with the following descriptions. Of course, other terminology known in the art may be used to convey the same, or similar, meaning presently utilized.

An electric vehicle may refer to a vehicle that is capable of being plugged into an external source of electrical energy, such as an electric power grid, to acquire some or all of its traction energy.

Electric vehicle supply equipment may refer to equipment external to an EV that is capable of delivering charging power to an EV at one or more levels of power, current, and voltage.

Other example systems and components associated with the electric vehicle ecosystem, though not exhaustively, may include the following.

Application software systems may refer to external systems that may interact with EVs and/or EVSEs to exchange information, report status, exert control, or implement other functions. Such systems are often implemented as network-based software applications within internet-connected data centers.

The electric power grid refers to an electricity network that may support one or more of electric power generation, electric power transmission, electric power distribution, and electric power control. The aforementioned electricity network may be implemented as a series of sub-networks, e.g., the transmission grid or distribution grid of a local utility or electricity vendor. The information systems referenced herein may be used to monitor, manage and control the electric grid.

### SUMMARY

Electric vehicle data-application connector systems render more efficient, if not entirely possible, the transfer of data between one or more programs of one or more application software systems with one or more EV or EVSE assets to efficiently accomplish, e.g., data collection, subscription management, location identification, power flow management, and consumer information management.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows examples of components associated with at least one embodiment of an electric vehicle-data application connector system (EV-DACS).

FIG. 2 shows an example of communication flows with respect to various components associated with at least one embodiment of an EV-DACS.

FIG. 3 shows an example of a communication flow according to at least one embodiment of an EV-DACS.

FIG. 4 shows an example of a general computer network environment that may be used to implement the techniques described herein.

### DETAILED DESCRIPTION

Described herein are systems, apparatuses, and methods related to managing flows of information between electric vehicle physical assets and interacting software assets. Such interacting software assets may serve to connect EVs and/or EVSEs with other information-processing systems including, but not limited to, personal computers or mobile phones. Examples of the systems include an Electric Vehicle Data-Application Connector System (alternately referred herein as “EV-DACS”), and examples of the electric vehicle physical assets include plug-in electric vehicles (alternately referred herein as “EV”) and electric vehicle supply equipment (alternately referred herein as “EVSE”).

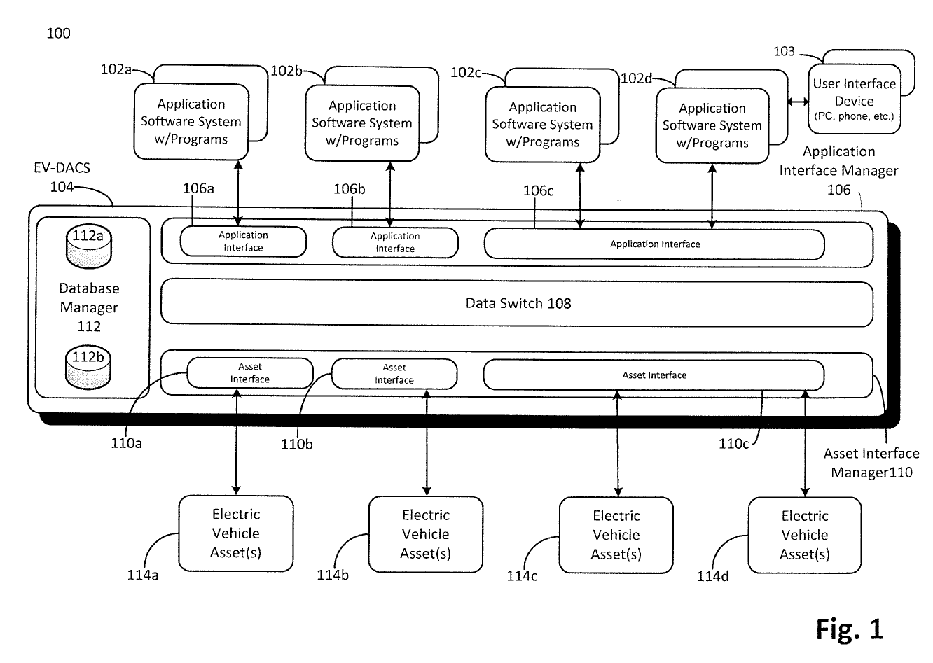

FIG. 1 shows system 100 that includes components associated with at least one embodiment of an EV-DACS to implement bi-directional communication between at least one of an EV and EVSE and one or more application software systems.

Application software systems 102a-102d may refer to external systems that may interact with EVs and/or EVSEs to exchange information, report status, exert control, or implement other functions. Such systems are often implemented as network-based software applications within internet-connected data centers, and may serve, for example, to connect EVs and/or EVSEs with other information-processing systems. Examples of such other information-processing systems may include, without being limited to, personal computers or mobile phones. Further, examples of application software systems may include, but are not limited to: data collection systems that gather operational data from EVs and/or EVSEs; subscription management systems that enable subscription-based charging services for EV owners and drivers; systems that identify or report EV or EVSE locations to owners or drivers; power flow management systems that enable smart charging and/or vehicle-to-grid services; and consumer information systems that deliver user-relevant information from EVs and EVSEs to owners or drivers.

Though only four such application software systems are depicted as part of system 100, no such quantitative limit is imposed.

User interface device 103 may refer to devices, e.g., personal computers, laptop computers, smart-phones, etc., to which the application software systems 102a-102d may connect to other information-processing systems.

EV-DACS 104 may refer to a mechanism, which may be implemented physically or virtually, to facilitate the invoking and/or management of application-level protocols to connect an electric vehicle asset with one or more programs associated with the application software systems for the purpose of exchanging information and/or controlling behavior of the electric vehicle asset.

EV-DACS 104 may facilitate communicative connections between one or more programs of an application software system by one manufacturer with one or more electric vehicle assets by another manufacturer. In addition, EV-DACS 104, as described herein, may facilitate efficient deployment of subsequently developed EV-related applications and physical assets within an environment of existing physical assets and applications and further facilitate information sharing among all applications and physical assets that make up system 100.

EV-DACS 104 may include, at least, an application interface manager 106, a data switch 108, an asset interface manager 110, and a database manager 112.

Application interface manager 106 is depicted as having multiple sub-managers 106a-106d, though such embodiments are illustrated and described only as an example. Application interface manager 106 may be implemented physically or virtually to manage connections and/or connection types between one or more software programs related to one or more of the application software systems 102a-102d and EV-DACS 104. The connection types and connections may be implemented as application-level protocols using standard internet protocols, .e.g., XML, SOAP, HTTPS, etc. The applications may be external to the EV-DACS 104, i.e., corresponding to one of application software systems 102a-102d, or internal to EV-DACS 104 and, therefore, running within the EV-DACS memory space with access to the runtime context thereof. Further, whether external or internal to the EV-DACS, the applications may be developed by the EV-DACS developer or by a third party.

Asset interface manager 110 is depicted as having multiple sub-managers 110a-110d, though such embodiments are illustrated and described only as an example. Application interface manager 110 may be implemented physically or virtually to manage connection types and specific connections between one or more of electric vehicle assets 114a-114d and EV-DACS 104. Examples of standards for such connection types and connections include, but are not limited to, SAE J1772, SAE J2836, ZigBee/HomePlug Smart Energy Profile, etc.

Data switch 108 may be implemented physically or virtually to manage connections among one or more of electric vehicle assets 114a-114d and EV-related software applications related to the one or more application software systems 102a-102d by invoking asset interfaces and application-level protocols as required by other EV-DACS subsystems.

Database manager 112 manages within, e.g., databases 112a and 112b, persistent information that may be required by subsystems related to EV-DACS 104.

Electric vehicle assets 114a-114d may refer to, either singularly or in combination, at least one EV and EVSE that is capable of delivering charging power to the EV at one or more levels of power, current, and voltage.

An electric vehicle (EV) as any one of electric vehicle assets 114a-114d may refer to a vehicle that is capable of being plugged into an external source of electrical energy, such as an electric power grid, to acquire some or all of its traction energy.

Electric vehicle supply equipment (EVSE) as any one of electric vehicle assets 114a-114d may refer to external equipment that is capable of delivering charging power to an EV at one or more levels of power, current, and voltage.

Industry standards for classifying charging schemes are known as Levels 1, 2 or 3 EVSE.

Level 1 (alternately referred herein as “L1”) EVSE may include standard plug/outlet combinations, such as NEMA 5-15 and 5-20, supports power levels up to, e.g., 120 VAC×20 amps, and enable charging wherever standard electrical outlets are available. L1 EVSE may typically include an extension cord equipped with a standard plug.

Level 2 (alternately referred herein as “L2”) EVSE may be wired into an electrical system that is part of the physical structure of, e.g., a home or place of business, and may support power levels up to, e.g., 240 VAC×70 amps (16.8 kW). L2 EVSE typically enables more rapid charging than L1 EVSE.

Level 3 (alternately referred herein as “L3”) EVSE may be wired into an electrical system that is part of the physical structure of, e.g., a home or place of business, and may deliver off-board DC power directly into the EV at power levels ranging from, e.g., 25-150 kW. L3 EVSE may facilitate “fast charging,” which competes with gasoline refueling times (typical L3 chargers can increase an EV battery pack's state-of-charge by, e.g., 50% within 10-15 minutes).

Though only four such electric vehicle assets are depicted as part of system 100, no such quantitative limit is imposed.

Further, the number of deployed EVs is likely to increase, creating technical challenges associated with the aforementioned example systems and methods.

For example, L1 EVSE, while ubiquitous, may be insufficient to meet EV users' typical daily needs because of its low power-transfer rate. Therefore, L2 residential EVSE may become the default charging system for many EV owners. Accordingly, as the number of EVs increases, L2 EVSE may also become ubiquitous at commercial, workplace and public locations; and L3 EVSE may also become more widespread, though in smaller numbers than L2 units, at commercial fast-charge locations.

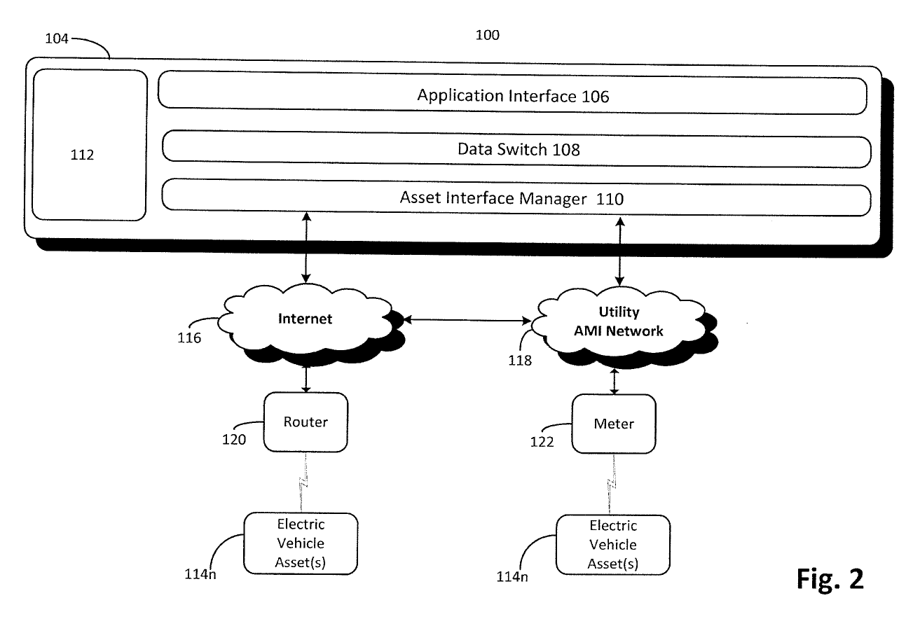

FIG. 2 shows another embodiment of system 100 that illustrates an example data flow among components associated with at least one embodiment of an EV-DACS 104.

Communication between electric vehicle assets 114n and EV-DACS 104 may occur over any available communication channel or combination thereof. Such communication may occur whether electrical vehicle asset 114n includes an EV, EVSE, or combination thereof, and may further involve other components such as, but not limited to, wireless router 120 or utility-owned smart meter 122.

More particularly, when EV-DACS 104 and electric vehicle asset 114n communicate via router 120, such communication is likely facilitated via the internet. An alternative embodiment may forego inclusion of router 120, and therefore electric vehicle asset 114n and EV-DACS 104 may communicate wirelessly via a cellular network, e.g., CDMA, GSM, etc.

And, when EV-DACS 104 and electric vehicle asset 114n communicate via smart meter 122, such communication is likely facilitated by any of the hard-wired or wireless infrastructures that may be implemented by a utility advanced metering infrastructure network 118.

Of course, interaction between one or more of electric vehicle assets 114n and EV-DACS 104 may be implemented by a combination of router 120 and smart meter 112, and therefore may be implemented over a combination of the internet 116 and utility AMI network 118 over either a hard-wired or a wireless connection.

Again, the interaction between the asset interface manager 110 of EV-DACS 104 and one or more of the electric vehicle assets 114n is to ultimately exchange information with one or more programs of an appropriate one or more of application software systems 102a-102d, report status to such one or more programs, allow control data or charging control to be taken by such one or more programs, or have other functions exerted thereon.

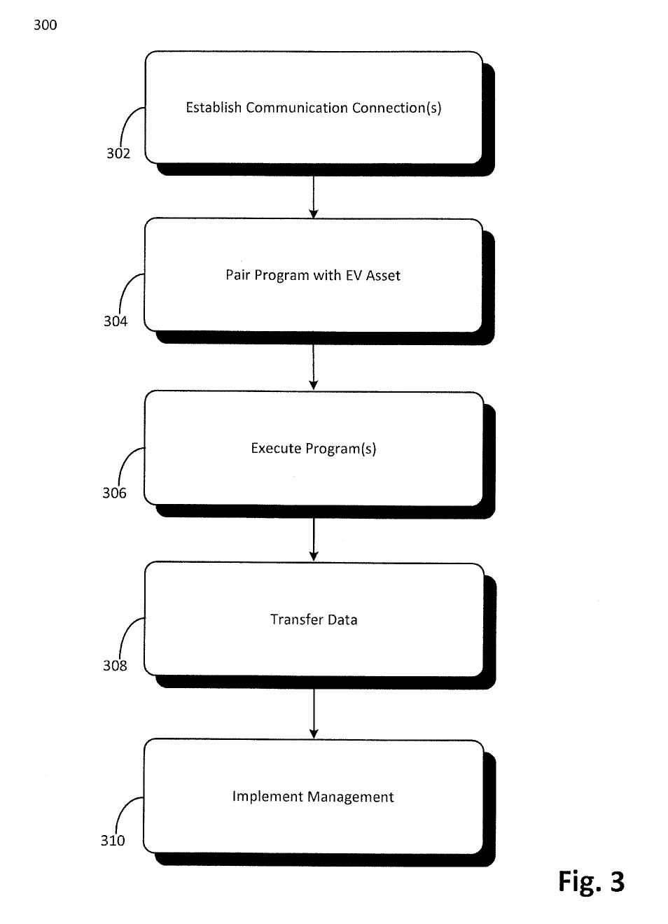

FIG. 3 shows example processing flow 300 associated with implementing an aforementioned exchange of information or exertion of control between one or more programs associated with an application software system 102a -102d and one or more electric vehicle assets 114a-114d via EV-DACS 104.

At block 302, communication with EV-DACS 104 is established by at least one of a program associated with one of the application software systems 102a-102d and one or more of electric vehicle assets 114a-114d. As set forth above, the relationship between the application software system and any one of the electric vehicle assets is, ultimately, one of monitoring or control. That is, utilizing the exchanges of information, reporting of status, etc., an appropriate program associated with one or more application software system is able to monitor or exert control over one or more electric vehicle assets. Thus, the application software systems may collect operational information from one or more EVs and/or EVSEs, enable subscription-based charging services for EV owners and drivers, identify or report EV or EVSE location, facilitate smart charging and/or vehicle-to-grid services for an EV and/or EVSE, and/or deliver user-relevant information from EVs and EVSEs to owners and drivers.

Communication on behalf of any one of the application software systems 102a-102d, EV-DACS 104 and electric vehicle assets 114a-114d may be implemented by a computing device having a processor, such as a computer (desktop or portable), mobile phone, or other such portable communication device.

At block 304, data switch 108 may implement and/or maintain a connection between the program of the appropriate one of application software systems 102a-102d and the appropriate one or more electric vehicle assets 114a-114d, by invoking the corresponding asset interfaces and application-level protocols.

At block 306, the program of the appropriate one of application software systems 102a-102d may be executed at EV-DACS 104, e.g., in the memory space thereof, physically or virtually. Alternatively, the program may even be executed externally, e.g., on a server hosted by a service provider or vendor. As set forth above, persistent information required by any component related to EV-DACS 104 may be managed by database manager 112, e.g., in at least one of databases 112a and 112b, though the present configuration is not exclusive.

At block 308, data switch 108 continues to manage the connection between the program of the appropriate one of application software systems 102a-102d and the appropriate one or more electric vehicle assets 114a-114d, thereby transferring data in either direction as necessary.

At block 310, upon completion of the necessary transfer of data, regardless of whether or not the program of the appropriate one of application software systems 102a-102d has fully executed, management of monitoring or control may then be implemented.

As set forth above, EV-DACS 104 may facilitate communicative connections between one or more programs of an application software system by one manufacturer with one or more electric vehicle assets by another manufacturer. Thus, the information transfer, management, and actual control of assets described herein are made more efficient, if not entirely possible, by the EV-DACS 104; whereas, without the EV-DACS 104, compatibility issues would likely render fruitless attempts at interacting between any one of application software systems 102a-102d and electric vehicle assets 114a-114d.

Accordingly EV-DACS 104 renders more efficient, if not entirely possible, the transfer of data between one or more programs of an application software system by one manufacturer with one or more electric vehicle assets by another manufacturer to efficiently facilitate charging control according to any standard, including, but not limited to, L1, L2, and L3 EVSE.

Scenarios for such charging control may include, but not be limited to:

a residential charging infrastructure, including individual or neighborhood-based EVSE deployments;

a commercial charging infrastructure deployed, e.g., in shopping mall parking lots;

workplace charging infrastructure deployed, e.g., in employer-provided parking lots;

public charging infrastructure deployed, e.g., in municipal parking lots;

emerging L3 EVSE-based fast-charging systems, deployed, e.g., in commercial settings such as service stations, to make EV recharging times comparable to gasoline refueling times;

existing battery fast-charging systems, deployed, e.g., in industrial applications such as material handling and airport ground-support;

grid-based charging management, including smart charging and vehicle-to-grid services;

rental car fleets;

car-sharing fleets;

solar photovoltaic (PV) charging systems deployed, e.g., within any of the above charging infrastructure settings;

subscription-based systems that enable charging across one or more of the above infrastructure settings; and

consumer information systems that combine information from one or more of the above examples to enable better consumer visibility of EV and energy usage.

It should be noted that the implementation illustrated in FIG. 3 and described above is not exclusive. That is, alternative embodiments of processing flow 300 may be implemented whereby the order of the actions is different or various actions are omitted, but the ultimate exchange of information and/or exertion of control is achieved.

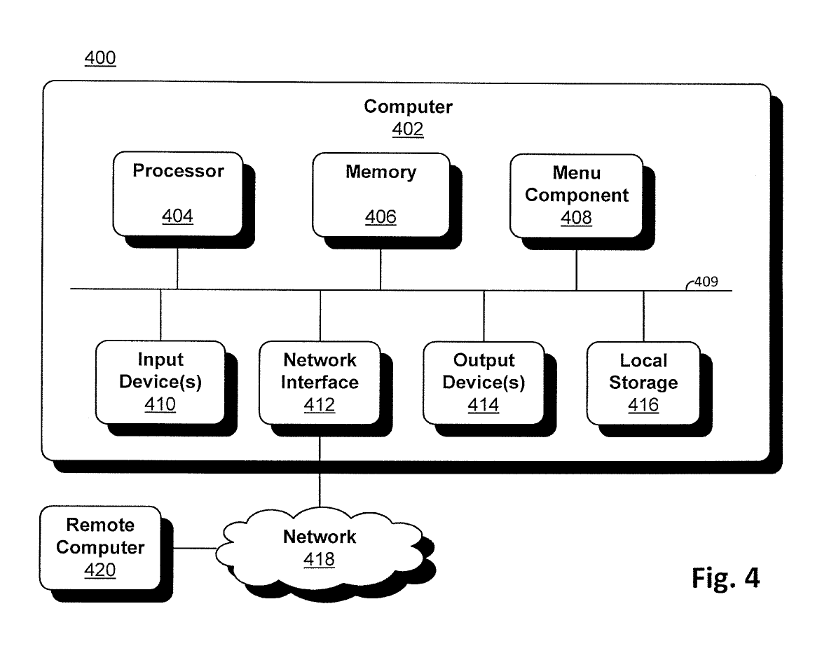

FIG. 4 illustrates a general computer environment 400, which can be used to implement the techniques described herein. The computer environment 400 is only one example of a computing environment and is not intended to suggest any limitation as to the scope of use or functionality of the computer and network architectures. Neither should the computer environment 400 be interpreted as having any dependency or requirement relating to any one or combination of components illustrated in the example computer environment 400.

Computer environment 400 includes a general-purpose computing device in the form of a computer 402, which may include one or more processors or processing units 404, system memory 406, menu component 408, and system bus 409 that couples various system components including processor 404 to system memory 406 and to menu component 408.

System bus 409 represents one or more of any of several types of bus structures, including a memory bus or memory controller, a peripheral bus, an accelerated graphics port, and a processor or local bus using any of a variety of bus architectures.

Computer 402 may include a variety of computer readable media. Such media can be any available media that is accessible by computer 402 and includes both volatile and non-volatile media, removable and non-removable media.

System memory 406 includes computer readable media in the form of volatile memory, such as random access memory (RAM), and/or non-volatile memory, such as read only memory (ROM) or flash RAM. Basic input/output system (BIOS), containing the basic routines that help to transfer information between elements within computer 402, such as during start-up, is stored in ROM or flash RAM. RAM typically contains data and/or program modules that are immediately accessible to and/or presently operated on by processing unit 404.

Computer 402 may also include other removable/non-removable, volatile/non-volatile computer storage media.

Any number of program modules can be stored on local storage 416, including e.g, an operating system, one or more application programs, other program modules, and program data 432.

A user can enter commands and information into computer 402 via input devices 410 such as a keyboard, a pointing device, or by touch. These and other input devices are connected to processing unit 404 via input/output interfaces that are coupled to system bus 409, but may be connected by other interface and bus structures, such as a parallel port, game port, or a universal serial bus (USB).

Computer 402 can operate in a networked environment using logical connections to one or more remote computers, such as remote computing device 420. By way of example, remote computing device 420 can be a PC, portable computer, a server, a router, a network computer, a peer device or other common network node, and the like.

In a networked environment, such as that illustrated with computing environment 400, program modules depicted relative to computer 402, or portions thereof, may be stored in a remote memory storage device. By way of example, remote application programs reside on a memory device of remote computer 420, such as a server hosted by a service provider or vendor, connected by network 416.

Various modules and techniques may be described herein in the general context of computer-executable instructions, such as program modules, executed by one or more computers or other devices. Generally, program modules include routines, programs, objects, components, data structures, etc. for performing particular tasks or implementing particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Further still, such computer storage media does not necessarily have to be local relative to computer 402. As “cloud computing” technologies continue to develop, such storage media may include servers that are hosted by service providers or vendors.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

We claim:

1. A system, comprising:
an electric transportation asset;
an application software system;
a connector system to invoke an application-level protocol to communicatively connect the electric transportation asset with the application software system.

2. The system of claim 1, wherein the electric transportation asset includes an electric vehicle.

3. The system of claim 1, wherein the electric transportation asset includes a device to provide a charge to or accept a charge from an electric vehicle.

4. The system of claim 1, wherein the application software system monitors or collects data from the electric transportation asset.

5. The system of claim 1, wherein the application software system controls the electric transportation asset.

6. The system of claim 1, wherein the application software system gathers operational data from EVs and/or EVSEs.

7. The system of claim 1, wherein the application software system manages subscription-based charging services for EV owners or drivers.

8. The system of claim 1, wherein the application software system identifies or reports EV or EVSE locations.

9. The system of claim 1, wherein the application software system manages power flow between EVs and/or EVSEs and an electric power grid.

10. The system of claim 1, wherein the application software system delivers user-relevant information from EVs or EVSEs to owners or drivers.

11. The system of claim 1, wherein the connector system executes a program associated with the application software system within a memory space therein.

12. The system of claim 1, wherein the connector system executes a program associated with the application software system within a physical or virtual machine therein.

13. The system of claim 1, wherein the connector system includes an asset interface manager to manage a connection with the electric transportation asset.

14. The system of claim 1, wherein the connector system includes an application interface manager to manage a connection with the application software system.

15. The system of claim 1, wherein the connector system includes a data switch to manage a connection between the electric transportation asset and a program associated with the application software system.

16. A computer-readable medium to store computer-executable instructions that, when read, cause at least one processor to:
interface with a program associated with an application software system;
interface with an electric transportation asset;
pair the program with the electric transportation asset;
execute the program; and
implement a data transfer between the program and the electric transportation asset.

17. The computer-readable medium according to claim 16, wherein the at least one processor is an electric vehicle data-application connector system that includes an application interface manager, an asset interface manager, a database manager, and a data switch.

18. The computer-readable medium according to claim 16, wherein the at least one processor is a virtual machine.

19. The computer-readable medium according to claim 17, wherein the data transfer is implemented, at least partially, via the internet.

20. The computer-readable medium according to claim 17, wherein the data transfer is implemented, at least partially, via an electric utility smart meter.

21. The computer-readable medium according to claim 17, wherein the data transfer is implemented, at least partially, via a wireless communication network.

22. The computer-readable medium according to claim 17, wherein the data transfer is implemented, at least partially, via a hard-wired communication network.

23. The computer-readable medium according to claim 17, wherein the data transfer is implemented, at least partially, according to a communication protocol associated with the electric transportation asset.

24. The computer-readable medium according to claim 17, wherein the computer-executable instructions that cause the at least one processor to implement the data transfer between the program and the electric transportation monitor or control the electric transportation asset.

25. A method, comprising:
establishing a communication connection with an electric transportation asset;
establishing a communication connection with an application software system;
pairing the electric transportation asset with a program associated with the application software system in accordance with a communication protocol corresponding to the electric transportation asset;
implementing data transfer between the electric transportation asset and the program associated with the application software system.
